(19) United States
(12) Patent Application Publication
(10) Pub. No.: US 2015/0294390 A1
(43) Pub. Date: Oct. 15, 2015

(54) INTERACTIVE COMPARISON SHOPPING

(71) Applicants: Guangbin FAN, (US); Qi LI, (US); Xuefeng SONG, (US); EMPIRE TECHNOLOGY DEVELOPMENT LLC, Wilmington, DE (US)

(72) Inventors: Guangbin FAN, Beijing (CN); Qi LI, Beijing (CN); Xuefeng SONG, Hebei (CN)

(21) Appl. No.: 14/647,655

(22) PCT Filed: Jun. 14, 2013
(86) PCT No.: PCT/CN2013/077255

§ 371 Date: May 27, 2015

(51) Int. Cl. G06Q 30/06

(52) U.S. Cl. CPC G06Q 30/0629; G06Q 30/0611; G06Q 30/0633

(57) ABSTRACT

To get better deals in shopping goods or services, e.g., quantity discount, potential purchasers may be encouraged to buy multiple items on a shopping list together from one supplier at wholesale prices. One or more suppliers may receive the shopping list and provide total prices for the potential purchasers.

### TECHNICAL FIELD

The technologies described herein pertain generally to electronic shopping lists that serve as a basis for interactive comparison shopping.

### BACKGROUND

Unless otherwise indicated herein, the approaches described in this section are not prior art to the claims in this application and are not admitted to be prior art by inclusion in this section.

Social networking services, e.g., e-commerce websites and applications that are directed towards improving users' shopping experiences may encourage shoppers to purchase more than one item with a single purchase order. Such purchases may be made by simply submitting the purchase order from a client device, e.g., laptop, tablet, cellphone, etc.

### SUMMARY

Technologies are generally described for interactive comparison shopping. The various techniques may be implemented in various devices, methods and/or systems.

In some examples, various techniques may be implemented on computing devices. Some techniques may include creating a shopping list comprising a plurality of items, submitting the shopping list to a server, and receiving one or more quotations that each provides a total price of the plurality of items on the shopping list.

In some examples, various embodiments may be implemented as systems. Some systems may include a client device configured to compose a shopping list comprising a plurality of items, a server configured to calculate a total price of the plurality of items based on one or more purchase opportunities from one or more suppliers, and a supplier configured to submit transaction information to the server component.

In some examples, various embodiments may be implemented as computer-readable mediums having executable instructions stored thereon. Some computer-readable mediums may store instructions that, when executed, cause one or more processors to perform operations comprising receiving a shopping list that includes a plurality of items, e.g., identification information of each of the plurality of items, from a wireless communication device; receiving one or more purchase opportunities for at least one of the plurality of items from one or more suppliers; recommending at least one alternative item for at least one of the plurality of items on the shopping list from a server; and generating one or more quotations that each provides a total price of the plurality of items on the shopping list.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items. In the drawings:

FIG. 1 shows an example system in which interactive comparison shopping may be implemented, arranged in accordance with at least some embodiments described herein;

FIG. 2 shows an example client device by which interactive comparison shopping may be implemented, arranged in accordance with at least some embodiments described herein;

FIG. 3 shows an example server application by which interactive comparison shopping may be implemented, arranged in accordance with at least some embodiments described herein;

FIG. 4 shows an example configuration of a processing flow of operations by which interactive comparison shopping may be implemented, arranged in accordance with at least some embodiments described herein; and

FIG. 5 shows a block diagram illustrating an example computing device that is arranged for interactive comparison shopping, arranged in accordance with at least some embodiments described herein.

### DETAILED DESCRIPTION

In the following detailed description, references are made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

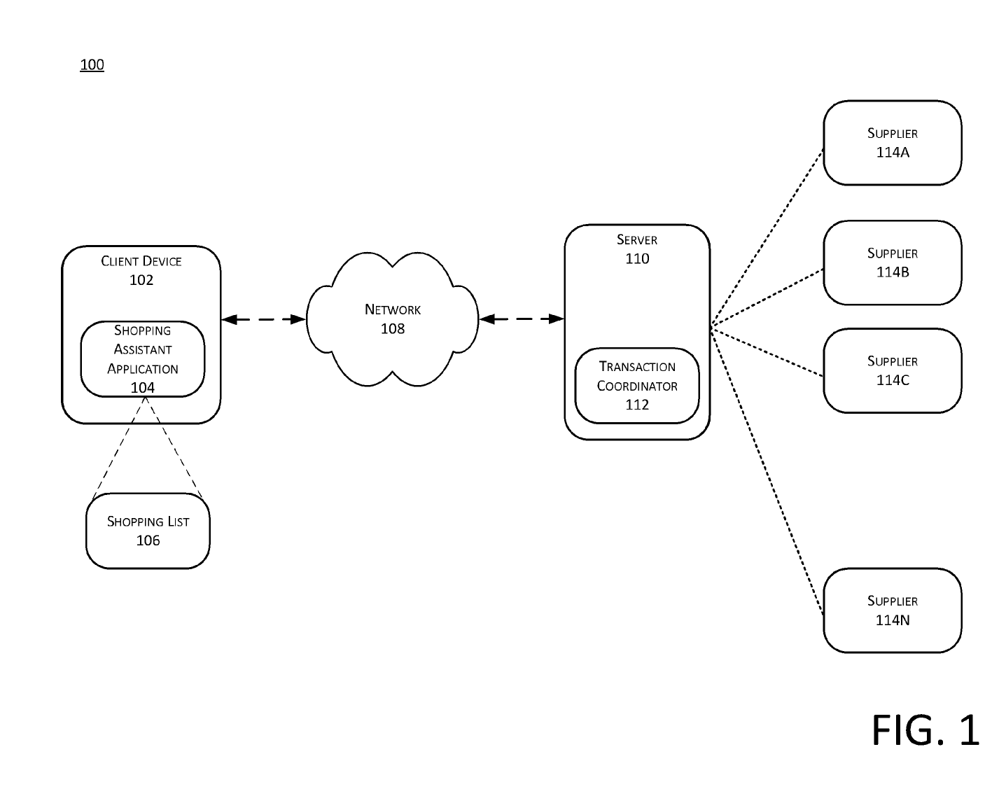

FIG. 1 shows an example system 100 in which interactive comparison shopping may be implemented, arranged in accordance with at least some embodiments described herein. As depicted, example system 100 may include, at least, a client device 102, an instance of shopping assistant application 104 hosted on client device 102, a shopping list 106 created on or by shopping assistant application 104, a network 108, a server 110 that may be communicatively coupled to client device 102, via network 108, and a transaction coordinator 112. Server 110 may be communicatively coupled to one or more suppliers 114A-114N. Unless context requires specific reference to one or more of suppliers 114A-114N, reference may be made to “suppliers 114” below.

Client device 102 may refer to a client device that is communicatively coupled to server 110, via network 108 and configured to execute arithmetic or logical operations, e.g., shopping assistant application 104. Client device 102 may include one or more hardware components including, but not limited to, Central Processing Units (CPU), physical storage space, memories, network ports, etc., and, further, peripheral devices for creating and organizing shopping list 106, e.g., camera for scanning barcodes of items on shopping list 106. In some examples, client device 102 may be implemented as wireless communication devices including tablets, laptops, or mobile phones.

Shopping assistant application 104 may refer to a software program, an instance of which may be hosted by client device 102, and that may be configured to create shopping list 106, to communicate with sever 110 and/or other client devices, and to execute one or more transactions for at least one of the items on shopping list 106.

Shopping list 106 may refer to a data structure configured to store information identifying or regarding items that a user may intend to purchase. Such information may include a name, specification, quantity, criteria, and/or preference for a corresponding item. For example, shopping list 106 may be implemented as a spread sheet including one or more columns filled with “milk,” “fat free,” “one carton,” “must be organic,” “brand A,” and “expiration date before Apr. 5, 2018.” Shopping list 106 may be created and organized by using the peripheral devices of client device 102 and, further, may be submitted to server 110 for price calculation. The user may further choose to share shopping list 106 with other potential purchasers, e.g., relatives, friends, classmates, etc., so that the other potential purchasers do not have to create a shopping list themselves or to share shopping lists for which notable discounts are available for one or more items. Of course, such motivating factors for sharing shopping list 206 are provided only as examples, and are not intended to be limiting in any manner.

Regardless, the sharing of discounts applied to shopping list 106 among potential purchasers may also benefit the business of suppliers 114. Client device 102 may be configured to create a barcode or a QR code for the shopping list that may be stored, transmitted, sent as email attachment, uploaded to social network websites, or otherwise shared with other potential purchasers. Alternatively, a backup file of shopping list 106 may be created on server 110, and a link to the backup file may be shared with other potential purchasers in accordance with one of the aforementioned implementations. Thus, the other potential purchasers may submit shopping list 106 to suppliers 114 get the same discount.

Alternatively, other potential purchasers may also modify shopping list 106 and submit the modified shopping list as a new shopping list to server 110. For example, a user who has received discounts and placed an order with respect to items on a shopping list, e.g., one carton of milk, two pounds of beef, and one bag of bread, may be willing to share this particular shopping list with contacts, e.g., friends, family, shopping club members. The user may create a barcode or a QR code that identifies the shopping list with a cellphone and text the barcode or QR code to the aforementioned contacts, or upload the barcode or QR code to a social networking service for the contacts to download. Accordingly, it is anticipated that the aforementioned contacts may receive the same or similar discount from suppliers 114 if they submit the same shopping list to server 110. In an alternative example, the aforementioned contacts may modify shopping list 106 received from the user by adding some additional items to shopping list 106 or deleting some items from shopping list 106 and, thus, may create a new shopping list and submit the new shopping list to server 110 for a renewed price calculation.

In some other examples, multiple shopping lists created by two or more users may be combined to generate a combined shopping list to get more discounts from suppliers 114. The discount of the combined shopping list may be apportioned based on an original price of the items on each shopping list. Each of the multiple shopping lists may then receive an apportioned discount. For example, a shopping list created by user A may include bread, tomatoes, and potatoes. Another shopping list created by user B may include pork, beef, and lamb. The respective original prices for shopping lists created by user A and user B may be 50 US dollars (USD) and 100 USD. User A and user B may exchange and combine their shopping list and create a combined shopping list. When supplier 114 provides 20% discount to the combined shopping list and, thus, saves the purchasers 30 USD, the 30 USD may be apportioned based on the original prices of each shopping list. That is, user A will get 10 USD off from the original price of the items on its shopping list. User B will get 20 USD off from the original price of the items on its shopping list.

In at least some examples, a user may utilize client device 102 to create shopping list 106 that includes one or more desired items. Shopping list 106 may be created by inputting the names of the items. Alternatively, the user may simply input one or more key words to describe the desired items. For example, “milk,” “lactose free,” and “fat free” may be input as key words for the instance of shopping assistant application 104 hosted on client device 102 to conduct further online searching or searching in an existing database stored on client device 102. One or more search results matching the key words may be listed for the user to select.

Shopping list 106 may alternatively be created, at least in part, by scanning barcodes or quick response (QR) codes associated with items. For example, when the user intends to purchase milk of same brand, same type, and same size, the user may simply utilize client device 102 to scan the barcode or OR code on the milk carton or an associated product display. Milk of same brand, same type, and same size may then be added to shopping list 106 accordingly.

Shopping list 106 may alternatively be created, at least in part, by taking pictures of items using a camera feature of client device 102. For example, a user that intends to buy tomatoes may take pictures of tomatoes utilizing the camera feature of client device 102, or the user may select existing pictures of tomatoes from albums stored on client device 102. Shopping assistant application 104 hosted on client device 102 may be configured to recognize tomatoes from the taken or selected pictures and then to add “tomatoes” to shopping list 106.

Further still, shopping list 106 may alternatively be created, at least in part, by utilizing a voice recognition capability of client device 102. That is, shopping assistant application 104, in cooperation with a voice recognition component of client device 102, may be configured to recognize the user's spoken words when the user speaks the names of the items and/or other relevant information including quantity, preference, criteria, etc. into a microphone coupled to client device 102. For example, client device 102 may be configured to add “two cartons of milk” to shopping list 106 when the user says “remind me to buy two cartons of milk on my way home” to client device 102.

Network 108 may refer to one or more communication links that follow at least one of communication protocols. The communication protocols may include any mobile communications technology, e.g., GSM, CDMA, etc., depending upon the technologies supported by particular wireless service providers. The one or more communication links may be implemented utilizing non-cellular technologies such as conventional analog AM or FM radio, Wi-Fi™, wireless local area network (WLAN or IEEE 802.11), WiMAX™ (Worldwide Interoperability for Microwave Access), Bluetooth™, hard-wired connections, e.g., cable, phone lines, and other analog and digital wireless voice and data transmission technologies.

Server 110 may refer to a physical computer, or a computer hardware system, dedicated to run one or more computing services, e.g., transaction coordinator 112, as a host to serve the needs of one or more subscribed users of a social networking service, including social networking services that provide shopping services. Server 110 may be programmed to carry out a set of arithmetic or logical operations including processing data, communicating with other client devices, etc. In order to perform the operations, server 110 may include one or more hardware components including, but not limited to, Central Processing Units (CPU), physical storage space, memories, network ports, etc. In accordance with some embodiments, server 110 may be configured to receive shopping list 106 from client device 102, submit shopping list 106 to one or more of suppliers 114A-114D, and receive purchase opportunities from one or more of suppliers 114A-114D for price comparison. Server 110 may be configured to store one or more discount rules, which may be received from suppliers 114. Such discount rules may include, e.g., discounts, coupons, or other group shopping information.

Transaction coordinator 112 may refer to a software program that may be configured to locate suppliers 114A, 114B, 114C, . . . , 114N, store the aforementioned discounts rules, transmit purchase recommendations to shopping assistant application 104 hosted on client device 102, and/or arrange delivery of the items on shopping list 106 to a location of the user of client device 102. In accordance with at least some examples, transaction coordinator 112 may be configured to conduct an online or offline search to obtain discounts, coupons, or group shopping information that relate to one or more of the items that are included on shopping list 106. For example, when the user of client device 102 utilizes shopping assistant application 104 to add, e.g., “one carton of milk of brand A” to shopping list 106, server 110 may conduct an online or offline search for discounts, coupons, or group shopping information related to Brand A milk. Examples of such search results, for descriptive purposes, may indicate that the user is eligible for a 50% discount when two or more cartons of Brand A milk are purchased, include a promotional code that may be applied to a purchase of Brand B milk may be used to instead save 30% off the purchase price of Brand A milk, etc. In accordance with some examples, transaction coordinator 112 may be configured to receive one or more purchase opportunities from suppliers 114A, 114, B, 114C, . . . , 114N that are generated to include a total price of the one or more items on shopping list 106. Transaction coordinator 112 may then be configured to select a best purchase opportunity for the user and transmit such purchase opportunity to a user device. The best purchase opportunity may be selected based on considerations that may be generated from the information contained in shopping list 106. For example, the best purchase opportunity may be an opportunity to purchase the items on shopping list 106 at the lowest total price transmitted from one of suppliers 114A, 114, B, 114C, . . . , 114N. In some other examples, the best purchase opportunity may be an opportunity to purchase items with superior quality at a regular or normal (i.e., non-discounted) price.

Suppliers 114A, 114B, 114C, . . . , 114N may refer to one or more entities configured to receive shopping list 106 from server 110, although alternate embodiments of interactive comparison shopping may contemplate shopping list 106 being received directly from client device 102. Unless context requires specific reference to one or more of suppliers 114A-114N, reference may be made to “suppliers 114” below. Suppliers 114 may be configured to calculate a total price of the items on shopping list 106. Each total price may then be transmitted, as a purchase opportunity, to server 110 for price comparison.

In accordance with some examples, to locate suppliers 114, shopping assistant application 104 hosted on client device 102 may transmit the location of client device 102 to server 110, together with shopping list 106. Alternatively, the location of client device 102 may be obtained by a locator device integrated therein, e.g., a Global Positioning System (GPS) module.

Transaction coordinator 112 hosted on server 110 may be configured to locate suppliers 114 among available suppliers, based on the received location of client device 102. Transaction coordinator 112 may determine with which of suppliers 114 to communicate based, e.g., on a predetermined maximum distance from client device 102 that was preset by the user of client device 102 and that was transmitted to server 110 along with, e.g., the location information. For example, besides creating shopping list 106, the user may preset the predetermined maximum distance as “5 miles” that indicates the user only intends to purchase the items from suppliers within 5 miles of the user's location, i.e., any determined location of client device 102. Transaction coordinator 112 hosted on server 110 may then only submit shopping list 106 to the suppliers within 5 miles of the user, e.g., suppliers 114. Alternatively, the user may preset a geographic area, and suppliers within the area may be located by server 110. For example, the user may input a postal zip code, e.g., 22314, or city name, e.g., Alexandria, Va. The suppliers in Alexandria, Va. may then be located for further communication.

When each of suppliers 114 receives shopping list 106, each of suppliers 114 may be configured to calculate a total price of the items on shopping list 106. The calculation may be conducted based on the aforementioned multiple discount rules stored on server 110. The multiple discount rules may consider the combination of the items on shopping list 106, the quantity of the items, the repeat rate of the shopping list, etc. One or more discount rules may be applied to shopping list 106, resulting in additional discount, relative to applying a single discount rule. For example, supplier 114A may provide discounts when the user intends to purchase a carton of milk and a pack of coffee beans. In addition, supplier 114A may provide more discount if the user has ordered same combination, i.e., milk and coffee beans, for more than a number of times in the past time period, e.g., four times in the past month. The multiple discount rules may be updated or modified by suppliers 114. In at least some embodiments, suppliers 114 may choose not to preset the discount rules. Instead, suppliers 114 may be configured to dynamically calculate a total price for each shopping list, e.g., calculate the total price according to the market price of each item on shopping list 106. Each total price may be transmitted to server 110 as a purchase opportunity. Suppliers 114 may also transmit, to server 110, other related information such as recommendations, substitutes of items on shopping list 106, etc.

Shopping assistant application 104 hosted on client device 102 may be configured to then access or receive the purchase opportunities transmitted to server 110. Shopping assistant application 104 may then enable the user of client device 102 to compare and choose one or more of the purchase opportunities or modify shopping list 106. Shopping assistant application 104 may further enable the user of client device 102 to subscribe the items of shopping list 106 to one or more of suppliers 114, and therefore to receive more discounts depending on the subscription frequency. That is, upon determining a favorable purchase opportunity, the user may choose to request, via shopping assistant application 104, automatic delivery a number of times in a time period. For example, when the user subscribes to a purchase of a carton of milk on a weekly basis, shopping assistant application 104 may place an order to one of suppliers 114 every week, and transaction coordinator 112 may arrange for the milk to be delivered by the supplier. A subscription of two cartons of milk every week, or a carton of milk every day, may receive more discounts than the aforementioned subscription. Payment may be processed via software programs executable on client device 102, e.g., an application (APP) on iPhone.

Thus, FIG. 1 shows an example system 100 in which interactive comparison shopping may be implemented, arranged in accordance with at least some embodiments described herein.

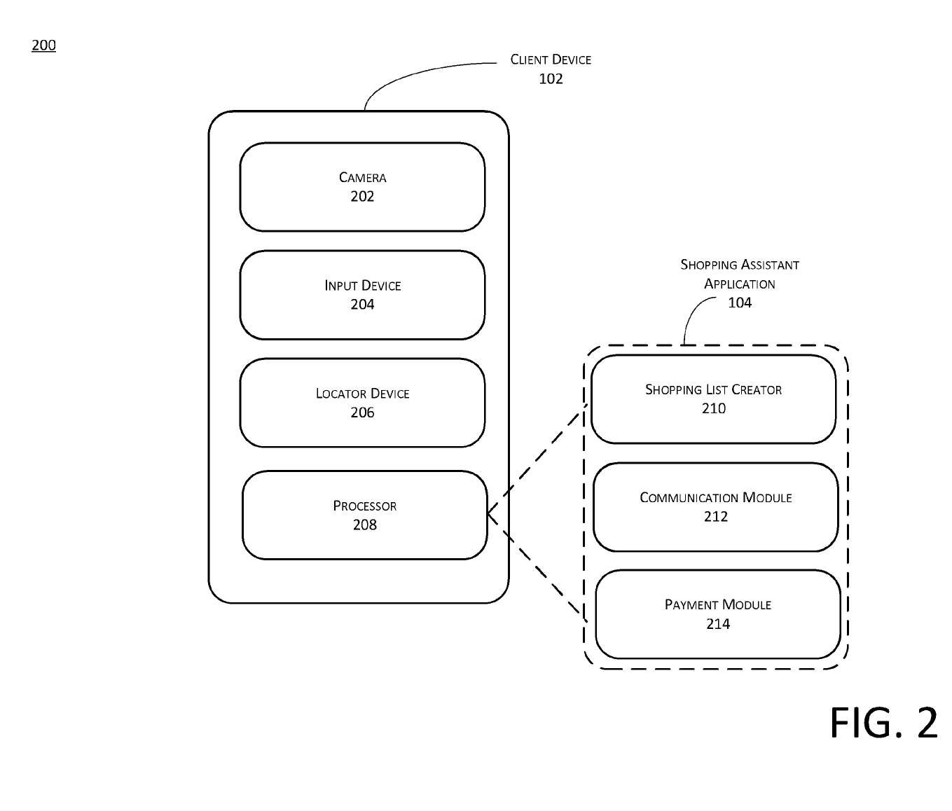

FIG. 2 shows an example client device 102 (200) hosting shopping assistant application 104 by which interactive comparison shopping may be implemented, arranged in accordance with at least some embodiments described herein. As depicted, client device 102 (200) may at least include a camera 202, an input device 204, a locator device 206, and a processor 208. Processor 208 may be configured to execute software modules including a shopping list creator 210, a communication module 212, and a payment module 214.

Camera 202 may refer to a physical device that is configured to capture digital images that may be stored and/or transmitted to, at least, server 110. Camera 202 may be configured to capture digital images of items that are listed on, or are intended to be listed on, shopping list 106 or to scan barcodes or QR codes of such items. The digital images and scanned barcodes or QR codes may be accessed by processor 208 for identification of the items.

Input device 204 may refer to one or more physical peripheral devices that is configured to receive information from an external source. Input device 204 may be implemented as a keyboard, a computer mouse, a microphone, a touchpad, etc. For example, a user may speak the names of the items and/or other relevant information, e.g., quantity, preference, criteria, etc. into a microphone. Client device 102 with voice recognition capabilities may be configured to interpret the user's spoken words for utilization by shopping assistant application 104.

Locator device 206 may refer to a physical device configured to determine a current location of client device 102. Locator device 206 may be implemented as, e.g., a Global Positioning System (GPS) navigation device configured to receive GPS signals that contain latitude and longitude information.

Processor 208 may refer to a physical component configured to execute programmed instructions of client device 102 by performing basic arithmetical, logical, and input/output operations, e.g., shopping assistant application 104.

Shopping assistant application 104 may include shopping list creator 210, communication module 212, and payment module 214.

Shopping list creator 210 may refer to a component or module that is configured to receive and process information retrieved from camera 202 and/or input device 204. In accordance with some examples, client device 102 may be utilized to create shopping list 106 that includes one or more items. Shopping list 106 may be created using input names of desired items, or one or more key words that are input to describe the desired items. Such names and/or key words may be input via input device 204. For example, a user may input “lactose free and fat free milk” in shopping list 106 via input device 204. Alternatively, “milk,” “lactose free,” and “fat free” may be input as key words, via input device 204, for shopping assistant application 104 to conduct further searching for potential suppliers. Such searching may be conducted online or in an existing database stored on client device 102. One or more search results that match or substantially match the input key words may be on a display of client device 102 by shopping assistant application 104 for the user to select.

Shopping list creator 210 may be configured to create shopping list 106 based on images of desired items taken by camera 202 or based on images of the desired items stored on client device 102. For example, the user who intends to purchase milk may capture one or more images of a milk package or carton with camera 202, or may select existing pictures of a milk package or carton from albums of images stored on client device 102. Accordingly, shopping list creator 210 may be configured to recognize a milk package or carton from either of the captured or stored images and to add “milk” to shopping list 106. As referenced herein, “package” may refer to a physical package that encloses a particular item, e.g., a bag for a loaf of bread, a carton for milk.

Similarly, shopping list creator 210 may also be configured to receive scanned images from camera 202, which may include scanned barcodes or quick response (QR) codes of existing packages of items. For example, when the user intends to purchase milk of a certain brand, a certain type, or a certain size, the user may simply utilize camera 202 to scan a bar code or QR code on a package or carton of a desired brand, type, and/or size of desired milk or on a corresponding display thereof. As a result, the brand, type, and/or size of the milk may then be added to shopping list 106 accordingly.

Further still, shopping list creator 210 may be configured to recognize the user's spoken words when the user uses input device 204, e.g., a microphone, to say the name of one or more desired items and/or other relevant information thereof, including a quantity, a preference of some kind, etc. For example, shopping list creator 210 may be configured to add “two cartons of milk” to shopping list 106 when client device 102 recognizes the user saying “remind me to buy two cartons of milk on my way home” to client device 102.

Communication module 212 may refer to a component or module that may be configured to communicate with transaction coordinator 112 hosted on server 110 and/or with other client devices that may be utilized by other potential purchasers. Communication module 212 may share shopping list 106 with other potential purchasers, e.g., relatives, friends, classmates, etc. In some examples, communication module 212 may be configured to create a barcode or a QR code for the package that may be stored, transmitted, sent as an email attachment, uploaded to one or more social network websites, or otherwise shared with other potential purchasers. Alternatively, in some other examples, a backup file of shopping list 106 may be created on server 110. Communication module 212 may share a link to the backup file with other potential purchasers so that other potential purchasers do not have to create another shopping list that contains the same items.

Payment module 214 may refer to a software component executable on processor 208. Payment module 214 may be configured to complete a transaction between the user of client device 102 and one of suppliers 114 for one or more of the items on shopping list 106 by submitting the user's payment information, e.g., credit card or debit card information, to transaction coordinator 112.

Thus, FIG. 2 shows an example client device 102 (200) by which interactive comparison shopping may be implemented, arranged in accordance with at least some embodiments described herein.

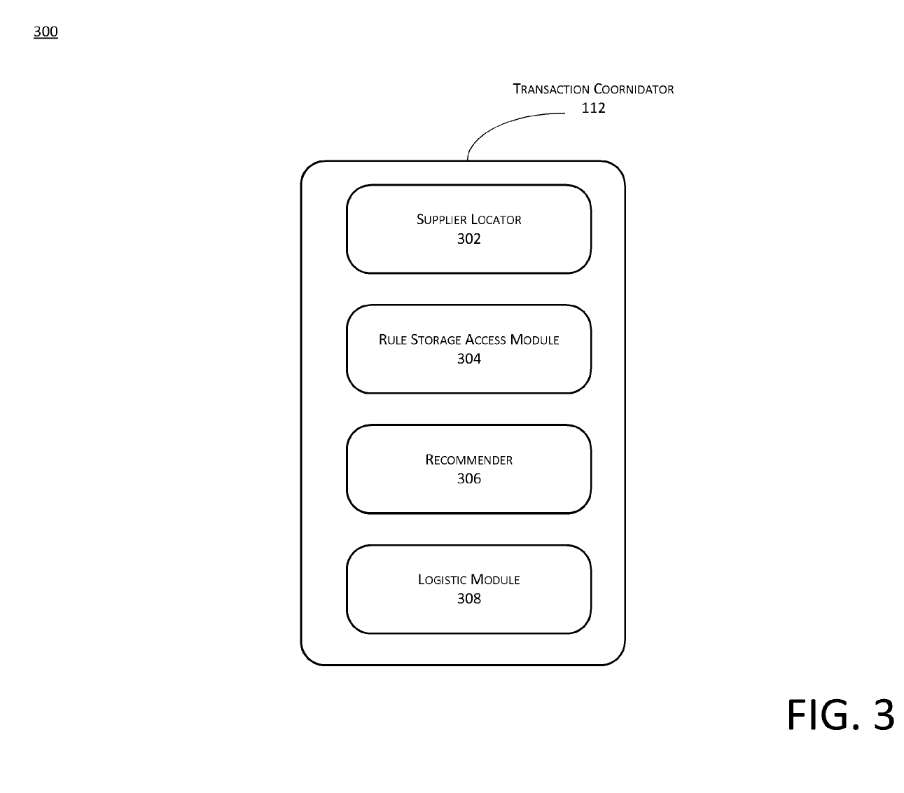

FIG. 3 shows an example transaction coordinator 112 by which interactive comparison shopping may be implemented, arranged in accordance with at least some embodiments described herein. As depicted, example transaction coordinator 112 may at least include a supplier locator 302, a rule storage access module 304, a recommender 306, and a logistic module 308.

Supplier locator 302 may refer to a component or module that may be configured to locate suppliers 114 based on, at least, a current location of client device 102, within a preset distance from client device 104. The user's location, i.e., location of client device 102, may be obtained by locator device 206, e.g., a Global Positioning System (GPS) module. Upon receiving the current location of client device 102, supplier locator 302 may be configured to locate suppliers 114 among available suppliers. Suppliers 114 may be determined based on a maximum distance from a determined location of client device 102 preset by the user via input device 204. For example, besides creating shopping list 106, the user may input the predetermined maximum distance as “5 miles” to indicate that the user only intends to purchase the items from suppliers within 5 miles of the user's current location. Server 110 may then only submit shopping list 106 to the suppliers within 5 miles of the user, e.g., suppliers 114. Alternatively, in accordance with other examples the user may input a geographic area and suppliers within the area may be located by supplier locator 302. For example, the user may input a postal zip code, e.g., 22314, or city name, e.g., Alexandria, Va. The suppliers in Alexandria, Va. may be located for further communication.

Rule storage access module 304 may refer to a component or module that may be configured to access storage or memory on server 110. The storage space may be configured to store data, instructions, operations, etc., to implement interactive comparison shopping. In at least some examples, rule storage access module 304 may be configured to accessmultiple discount rules received from suppliers 114 and stored on the storage space. The multiple discount rules may serve as a basis for suppliers 114 to calculate the total price for each shopping list 106. The multiple discount rules may consider the combination of the items on shopping list 106, the quantity of the items, the repeat rate of the shopping list, etc. For example, supplier 114A may provide discounts when the user intends to purchase a carton of milk and a pack of coffee beans. In addition, supplier 114A may provide one or more discounts if the user has ordered the same combination of items, i.e., milk and coffee beans, periodically over a predetermined amount of time, e.g., four times in the past month. The multiple discount rules may be updated or modified by suppliers 114.

Recommendation module 306 may refer to a component or module that may be configured to recommend similar or equivalent items of the items on shopping list 106 to the user, as one or more alternative selections to items on shopping list 106 that include specific criteria, e.g., brand, size, type, cost, etc. For example, when shopping list 106 includes “one carton of milk of brand A,”, recommendation module 306 may be configured to search for discounts, coupons, or group shopping information related to “milk of brand A” among potential suppliers that are not limited to suppliers 114. The search results may, for instance, suggest that the user may be eligible for a 50% discount if he or she purchases additional items such as another carton of brand A milk A or a bag of coffee beans; a promotion code may be applied to brand B milk to save 30% of the price of brand A milk; etc. Accordingly, recommender 306 may then transmit, to client device 102, recommendations of purchasing two cartons of brand A milk or purchasing brand B milk.

Logistic module 308 may refer to a component or module configured to arrange one of suppliers, e.g., supplier 114A, to prepare one or more selected items for pick-up by the user or for delivery thereto.

Thus, FIG. 3 shows an example server 110 (300) by which interactive comparison shopping may be implemented, arranged in accordance with at least some embodiments described herein.

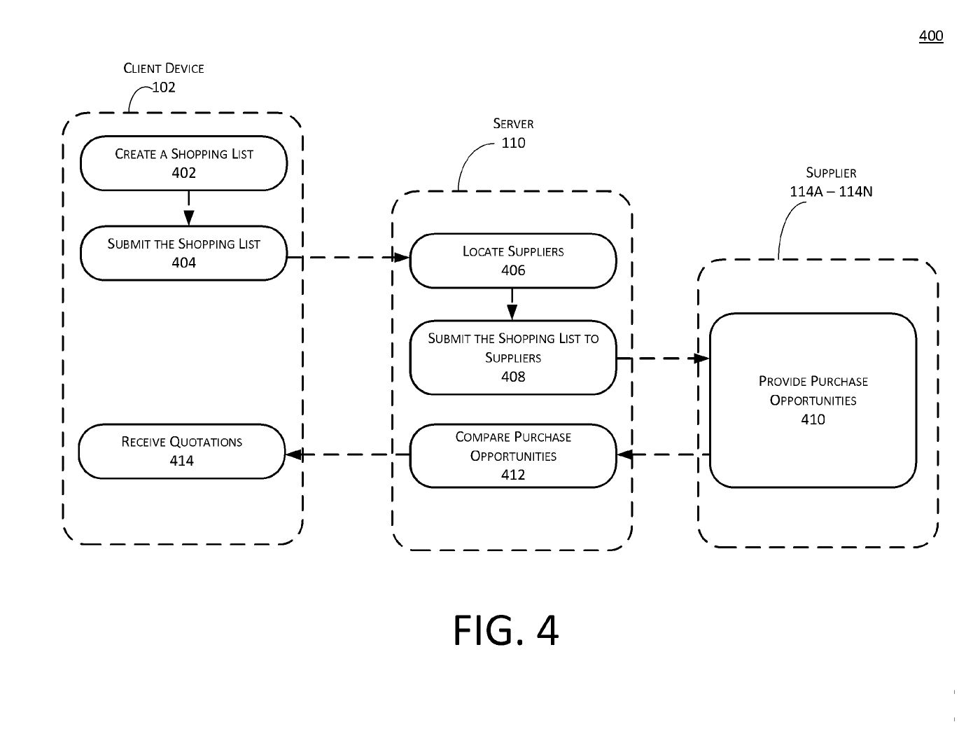

FIG. 4 shows an example configuration of a processing flow 400 of operations by which interactive comparison shopping may be implemented, arranged in accordance with at least some embodiments described herein. As depicted, processing flow 400 may include sub-processes executed by various components that are part of example system 100. However, processing flow 400 is not limited to such components, and modification may be made by re-ordering two or more of the sub-processes described here, eliminating at least one of the sub-processes, adding further sub-processes, substituting components, or even having various components assuming sub-processing roles accorded to other components in the following description. Processing flow 400 may include various operation, functions, or actions as illustrated by one or more of blocks 402, 404, 406, 408, 410, 412, and/or 414. Processing may begin at block 402.

Block 402 (Create a Shopping List) may refer to shopping list creator 210 creating shopping list 106 that includes a plurality of items. To create shopping list 106, shopping list creator 210 may adopt different methods to receive or input identification of items desired by a user of client device 102. The identification information may include item names input by the user, scanned barcodes or QR codes, captured or stored digital of items, key words describing the items, spoken words, etc. Processing may continue from block 402 to 404.

Block 404 (Submit the Shopping List) may refer to communication module 212 submitting shopping list 106 to server 110 over network 108. Network 108, which may or may not be a wireless network, may include the Internet, intranet or extranet. Processing may continue from block 404 to 406.

Block 406 (Locate Suppliers) may refer to supplier locator 302 locating suppliers 114 based on, at least, a current location of client device 102 and a preset maximum distance therefrom. The user's location may be obtained by locator device 206, e.g., a Global Positioning System (GPS) module. Upon receiving the current location of client device 102, supplier locator 302 may be configured to locate suppliers 114 among available suppliers. Suppliers 114 may be determined based on a predetermined maximum distance from client device 102 preset by the user via input device 204. Processing may continue from block 406 to 408.

Block 408 (Submit the Shopping List to Suppliers) may refer to server 110 submitting shopping list 106 to the determined suppliers 114. Processing may continue from block 408 to 410.

Block 410 (Provide Purchase Opportunities) may refer to each of the determined suppliers 114 calculating a total price for the items on shopping list 106 and transmitting the total prices to server 110. The calculation may be conducted based on the aforementioned multiple discount rules stored in a storage space on server 110. The multiple discount rules may consider the combination of the items on shopping list 106, the quantity of the items, the repeat rate of the shopping list, etc. The multiple discount rules may be updated or modified by suppliers 114. In at least some embodiments, suppliers 114 may choose not to preset the discount rules. Instead, suppliers 114 may be configured to dynamically calculate a total price for each shopping list, e.g., calculate the total price according to the market price of each item on shopping list 106. Each total price may be transmitted to server 110 as a purchase opportunity. Suppliers 114 may also transmit, to server 110, other related information such as recommendations, substitutes of items on shopping list 106, etc. Processing may continue from block 410 to 412.

Block 412 (Compare Purchase Opportunities) may refer to server 110 comparing the purchase opportunities transmitted from suppliers 114. In at least some examples, the purchase opportunities may be sorted in an ascending or descending order of total price. Processing may continue from block 412 to 414.

Block 414 (Receive Quotations) may refer to client device 102 receiving quotations, i.e., the purchase opportunities, from server 110. The user may compare and choose one from the purchase opportunities or modify shopping list 106. The user may also choose to subscribe the items of shopping list 106 and may receive more discounts depending on the subscription frequency. That is, upon determining a favorable purchase opportunity, the user may choose to request automatic delivery a number of times in a time period. The user may then make payment via payment module 214 executable on client device 102, e.g., an application (APP) on iPhone.

Thus, FIG. 4 shows an example configuration of a processing flow 400 of operations by which interactive comparison shopping may be implemented, arranged in accordance with at least some embodiments described herein.

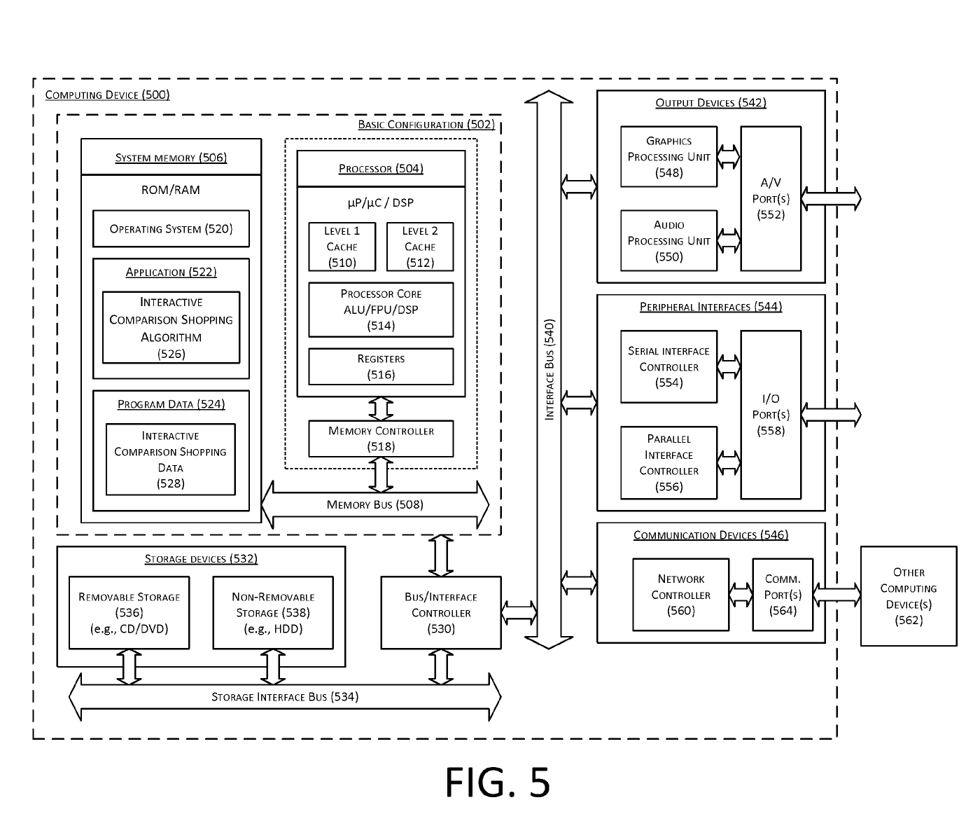

FIG. 5 shows a block diagram illustrating an example computing device that is arranged for interactive comparison shopping, arranged in accordance with at least some embodiments described herein.

In a very basic configuration 502, computing device 500 typically includes one or more processors 504 and a system memory 506. A memory bus 508 may be used for communicating between processor 504 and system memory 506.

Depending on the desired configuration, processor 504 may be of any type including but not limited to a microprocessor (μP), a microcontroller (μC), a digital signal processor (DSP), or any combination thereof. Processor 504 may include one more levels of caching, such as a level one cache 510 and a level two cache 512, a processor core 514, and registers 516. An example processor core 514 may include an arithmetic logic unit (ALU), a floating point unit (FPU), a digital signal processing core (DSP Core), or any combination thereof. An example memory controller 518 may also be used with processor 504, or in some implementations memory controller 518 may be an internal part of processor 504.

Depending on the desired configuration, system memory 506 may be of any type including but not limited to volatile memory (such as RAM), non-volatile memory (such as ROM, flash memory, etc.) or any combination thereof. System memory 506 may include an operating system 520, one or more applications 522, and program data 524. Application 522 may include an interactive comparison shopping algorithm 526 that is arranged to perform the functions or operations as described herein including those described with respect to process 400 of FIG. 4. To perform process 400, computing device 500 may be integrated with client device 102, server 110, and/or suppliers 114. Program data 524 may include interactive comparison shopping data 528 that may be useful for operations with interactive comparison shopping algorithm 528 as is described herein. For example, interactive comparison shopping data 528 may include the prices of items on shopping list 106, the discount rules received from suppliers 114, etc. In some embodiments, application 522 may be arranged to operate with program data 524 on operating system 520 such that implementations of interactive comparison shopping may be provided as described in accordance with example system 100, example client device 200, and example server application 300 as described in FIGS. 1-3. This described basic configuration 502 is illustrated in FIG. 5 by those components within the inner dashed line.

Computing device 500 may have additional features or functionality, and additional interfaces to facilitate communications between basic configuration 502 and any required devices and interfaces. For example, a bus/interface controller 530 may be used to facilitate communications between basic configuration 502 and one or more data storage devices 532 via a storage interface bus 534. Data storage devices 532 may be removable storage devices 536, non-removable storage devices 538, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 506, removable storage devices 536 and non-removable storage devices 538 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

Computing device 500 may also include an interface bus 540 for facilitating communication from various interface devices (e.g., output devices 542, peripheral interfaces 544, and communication devices 546) to basic configuration 502 via bus/interface controller 530. Example output devices 542 include a graphics processing unit 548 and an audio processing unit 550, which may be configured to communicate to various external devices such as a display or speakers via one or more A/V ports 552. Example peripheral interfaces 544 include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 546 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 500 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 500 may also be implemented as a personal computer including both laptop computer and non-laptop computer configurations.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A method, comprising:
creating a shopping list comprising a plurality of items;
submitting the shopping list to a server; and
receiving one or more quotations that each provides a total price of the plurality of items on the shopping list.

2. The method of claim 1, wherein the creating includes inputting identification information of each of the plurality of items to a wireless communication device.

3. The method of claim 2, wherein the inputting includes:
scanning a barcode of each of the plurality of items using a camera of the wireless communication device, or
capturing a picture of each of the plurality of items with the camera.

4. (canceled)

5. The method of claim 1, wherein the shopping list includes a name, a specification, a quantity, one or more criteria, and a preference for each of the plurality of items.

6. The method claim 2, wherein the server calculates the total price of the plurality of items based on one or more purchase opportunities from one or more suppliers.

7. The method of claim 6, wherein the one or more purchase opportunities from the one or more suppliers includes a discount based on one or more of a combination of the plurality of items, a quantity value, or a repeat rate of the shopping list.

8. The method of claim 6, wherein the server calculates the total price of the plurality of items by further applying one or more pre-existing coupons from the one or more suppliers to the shopping list.

9. The method of claim 6, wherein the one or more suppliers are located within a predetermined distance of a user or within a geographical area defined by an input of the user.

10. The method of claim 9, wherein a location of the user is determined by a Global Position System component of the wireless communication device.

11. (canceled)

12. The method of claim 1, wherein the receiving includes receiving one or more recommendations, wherein the one or more recommendations include information of one or more alternative items to at least one of the plurality of items on the shopping list.

13. The method of claim 9, wherein the submitting includes submitting the plurality of items on the shopping list to a database based on a frequency determined by the user.

14. The method of claim 13, wherein the server receives at least one discount offer from the one or more suppliers having access to the database.

15. The method of claim 1 further comprising sharing the shopping list with one or more purchasers.

16. A system, comprising:
a client device configured to compose a shopping list comprising a plurality of items;
a server configured to calculate a total price of the plurality of items based on one or more purchase opportunities from one or more suppliers; and
a supplier configured to submit transaction information to the server.

17. The system of claim 16, wherein the client device is configured to receive identification information of each of the plurality of items.

18. The system of claim 17, wherein the identification information includes one of a barcode, a picture, or a Quick Response Code (QR Code).

19. The system of claim 16, wherein the client device is integrated to a wireless communication device.

20. The system of claim 19, wherein the server is configured to receive a location from the client device to choose the one or more suppliers.

21. The system of claim 20, wherein the location is determined by a Global Position System component of the wireless communication device or by an input indicating a geographical area.

22. (canceled)

23. The system of claim 16, wherein the client device is further configured to compose the shopping list based on one or more of a quantity, a brand preference, or a preferred expiration date.

24. The system of claim 16, wherein the server is configured to receive a discount from the one or more suppliers based on one or more rules including a combination of the plurality of items, a quantity value, or a repeat rate of the shopping list.

25. The system of claim 16, wherein the server is configured to apply one or more pre-existing coupons from the one or more suppliers to the shopping list.

26. The system of claim 16, wherein the server is configured to make one or more recommendations including information of one or more alternative items to at least one of the plurality of items on the shopping list.

27. The system of claim 16, wherein the client device is configured to submit the plurality of items on the shopping list to a database based on a frequency determined by a user.

28. The system of claim 27, wherein the server is configured to receive a discount from the one or more suppliers having access to the database.

29. The system of claim 16, wherein the client device is configured to share the shopping list with one or more purchasers.

30. A non-transitory computer-readable medium storing instructions that, when executed, cause one or more processors to perform operations comprising:
receiving a shopping list comprising a plurality of items including identification information of each of the plurality of items from a wireless communication device;
receiving one or more purchase opportunities for at least one of the plurality of items from one or more suppliers;
recommending at least one alternative item for at least one of the plurality of items on the shopping list from a server; and
generating one or more quotations that each provides a total price of the plurality of items on the shopping list.

31. The computer-readable medium according to claim 30,
wherein the identification information includes at least one of a name of an item, a barcode corresponding to an item, a Quick Response Code (QR Code) corresponding to an item, or a picture of an item.
